(19) United States
(12) Patent Application Publication
(10) Pub. No.: US 2007/0284302 A1
(43) Pub. Date: Dec. 13, 2007

(54) WATER PERMEABLE COMPOSITE MATERIAL FOR PREVENTING MIGRATION OF SOIL AND/OR SAND PARTICLES INTO DRAINAGE SYSTEM

(75) Inventor: Charles R. Blackwood, Oklahoma City, OK (US)

Correspondence Address: DUNLAP CODDING & ROGERS, P.C., PO BOX 16370, OKLAHOMA CITY, OK, 73113, US

(73) Assignee: Airfield Systems, L.L.C.

(21) Appl. No.: 11/759,342

(22) Filed: Jun. 7, 2007

Related U.S. Application Data
(60) Provisional application No. 60/811,567, filed on Jun. 7, 2006.
(60) Provisional application No. 60/880,264, filed on Jan. 12, 2007.

(51) Int. Cl. B01D 29/00

(52) U.S. Cl. 210/490; 210/499; 210/503; 405/36; 428/304.4

(57) ABSTRACT

A composite filter material comprising a filter layer and a support layer bonded together. The filter layer is formed of a flexible, liquid-permeable non-woven fabric having a plurality of openings sized to permit liquids and silt particles to pass through the filter layer while preventing sand particles from passing through the filter layer. The support layer is formed of a flexible, liquid-permeable material having a grab tensile strength greater than that of the filter layer, the support layer having a plurality of openings such that the support material is at least as permeable to liquids as the filter fabric. In another embodiment, the composite filter material further comprises a drainage panel bonded to at least one of the filter layer or the support layer. The drainage panel has a laterally-extensive backing grid and a plurality of spaced-apart support members projecting from the backing grid whereby fluid may flow through the backing grid and between the support members. Novel methods of forming the composite filter material are also disclosed, as well as a sandtrap utilizing the composite filter material and a method of constructing such a sandtrap.

### CROSS-REFERENCE TO RELATED APPLICATIONS

This application claims the benefit of U.S. Provisional Applications Nos. 60/811,567, filed Jun. 7, 2006; and 60/880,264, filed Jan. 12, 2007; both of which are incorporated herein by reference in their entirety.

### BACKGROUND OF THE INVENTION

1. Field of the Invention

The present invention relates to a composite material, and more particularly, but not by way of limitation, to a water-permeable composite filter material for preventing migration of soil and/or sand particles into a drainage system.

2. Brief Description of Related Art

Problems have been encountered in preventing migration of soil and/or sand particles into a drainage system, while at the same time providing adequate drainage of water through the soil and/or sand. Such problems often occur in paved and unpaved roads, industrial yards, landfills, waste handling systems, landscapes, and recreational facilities such as football fields, baseball parks, race tracks, golf courses, especially in sandtraps, also known as sand bunkers, and the like. Further, uncontrolled drainage of water through the soil or sand often results in erosion problems.

The prior art is replete with various types of systems and materials for attempting to permit water to flow into a subterranean drainage system while reducing migration of soil particles and/or sand into the drain. While such prior art systems have met with some success, a need exists for new and improved materials which will not only prevent migration of soil particles and/or sand into the drain, but which will also readily permit water to flow through the soil particles and into the drain or drainage system. Such material should be durable, abrasion resistant, and economical to manufacture. It is to such composite material that the present invention is directed.

### SUMMARY OF THE INVENTION

According to the present invention, a composite filter material is provided which can be used to prevent the migration of soil and/or sand particles into a drainage system, while permitting water to flow through the soil and/or sand. Such material can be used in the construction of paved and unpaved roads, industrial yards, landfills, waste handling systems, as a component for landscapes and recreational facilities such as football fields, baseball parks, race tracks, golf courses and the like. Broadly, the composite material includes a first filter layer formed of a non-woven fabric and a second support layer formed of another water-permeable sheet of material. The filter layer is formed of a liquid-permeable, non-woven fabric having a plurality of openings sized to permit silt and other fine particles to pass through the filter layer. The support layer is formed of a second sheet of material having a plurality of openings so as to be at least as permeable to liquids as the filter layer.

The filter layer and the support layer of the composite material may be assembled and bonded together by any suitable technique known to those skilled in the art, including, but not limited to, mechanical techniques (including sonic, needle punch techniques, sewing, stapling, rivets and the like), chemical and/or thermal bonding techniques, provided that the method of bonding the materials together does not interfere with the water permeability of the composite material or with the strength of the composite material to prevent migration of soil and/or sand particles therethrough and into a drainage system. In one embodiment, the composite material further includes a drainage panel bonded to at least one of the filter layer or the support layer. Additionally, an improved sandtrap is disclosed utilizing at least one embodiment of a composite drainage material constructed in accordance with the present invention. Methods are also provided for constructing various embodiments of the composite filter material, as well as the sandtraps described herein.

### BRIEF DESCRIPTION OF THE DRAWINGS

FIG. 1 is a perspective view of a sheet of composite material formed of a first filter layer and a second support layer formed in accordance with the present invention.

FIG. 2 is a perspective view of a sheet of a knitted fabric utilized as the support layer of the composite material of FIG. 1, an upper corner of the sheet of material being upwardly turned to show a lower surface thereof.

FIG. 3 is a perspective view of a sheet of a non-woven fabric employed as the filter layer of the composite material of FIG. 1, a corner of the sheet being upwardly turned to show a lower surface thereof.

FIG. 4 is a perspective view of a portion of one embodiment of a sandtrap constructed in accordance with the present invention.

FIG. 5 is a perspective view of a portion of a second embodiment of a sandtrap constructed in accordance with the present invention.

### DETAILED DESCRIPTION OF EXEMPLARY EMBODIMENTS

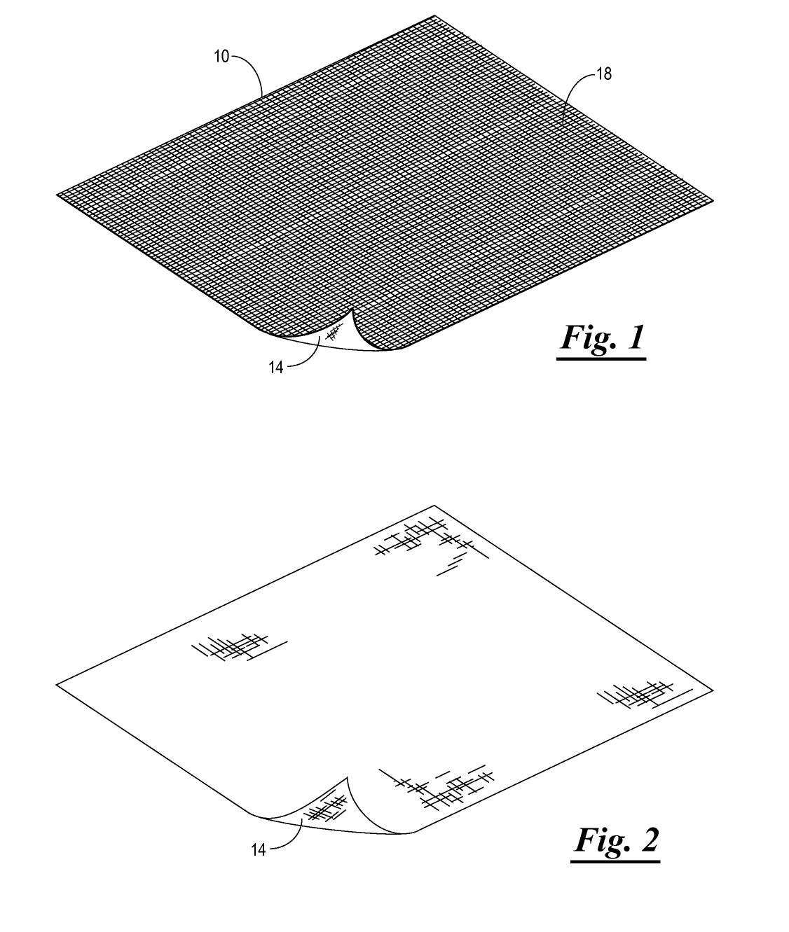

Referring now to the drawings, and more particularly to FIG. 1, shown therein is a composite material 10 constructed in accordance with the present invention. The composite material 10 includes a first filter layer 14 of a liquid-permeable non-woven fabric and a second support layer 18 of a material having a plurality of openings so as to be at least as permeable to liquids as the filter layer 14. The filter layer 14 and support layer 18 of the composite material 10 are preferably assembled and bonded together by any suitable technique known to those skilled in the art, including, but not limited to, mechanical techniques (including sonic, needle punch, sewing, stapling, rivets and the like), and/or chemical and/or thermal techniques, provided that the method of bonding the filter layer 14 and the support layer 18 together does not substantially interfere with the water permeability of the composite material 10 or the integrity of the composite material 10, such that liquids are permitted to pass through the composite material 10 and soil and/or sand particles are prevented from migrating or otherwise passing through the composite material 10, such as into a drainage system.

Ideally, the filter layer 14 and the support layer 18 to provide a composite filter material 10 having a high flow rate. The filter material 14 preferably serves as a primary filter for the composite material 10. Specifically, the filter material 14 is permeable to liquids and preferably has openings sized such that sand and soil particles are substantially prevented from passing through the filter layer 14. To prevent clogging, the filter layer 14 preferably permits silt and other similarly-fine particles, or fines, of sand, soil or gravel to pass therethrough while preventing the larger particles, such as sand, from passing therethrough.

The support layer 18 preferably has sufficient strength and integrity to prevent deterioration of the composite material 10 by the abrasive action of sand, soil and/or gravel supported thereon, as well as impact by an object, such as a rake when the composite material 10 is used in a sand bunker of a golf course. The support layer 18 also preferably has a plurality of openings sized such that the support layer is at least as permeable to liquids as the filter layer 14. The support layer 18 is preferably more permeable to liquids than the filter layer 14, such that the flow of liquids through the composite material 10 is not substantially impeded. For example, the support layer 18 may be highly-permeable so as to permit sand and soil particles to pass through the support layer 18, preferably while prohibiting larger materials, such as gravel and rocks, from passing through the support layer 18, thereby protecting the filter layer 14. When the support layer 18 and the filter layer 14 are combined, the composite filter material 10 is preferably nearly as permeable to liquids as the filter layer 14 alone, as well as nearly as durable as the support layer 18. That is, the filter layer 14 and the support layer 18 cooperate to function as a filter having a high flow rate, while the support layer 18 also functions as an impact netting to prevent damage to the filter layer 14 due to abrasive action on the composite filter material 10. To this end, it may be preferable in some applications to install the composite filter material 10 such that support layer 18 faces up, and the filter layer 14 faces down, so the support layer 18 more-adequately protects the filter layer 14.

Referring now to FIG. 2, the filter layer 14 may be formed of any suitable non-woven fabric that can be bonded to the material of the support layer 18 of the composite material 10. In many embodiments, it may be desirable to form the filter layer 14 of a polymeric non-woven fabric. Such polymeric non-woven fabrics are, in many instances, more resistant to erosion, degradation, and deterioration, from UV radiation for example, than natural fibers. To this end, it may also be desirable to treat the fabric of the filter layer 14, and/or the material of the support layer 18, to be resistant to UV radiation. Further, it is desirable that the material from which the filter layer 14 of the composite filter material 10 is fabricated have an open structure which creates a fiberglass-like fabric having a desired flexibility.

One suitable fabric is a polyester spun-bonded non-woven fabric having a weight of about 1.76 oz/yd² and a grab tensile strength of from about 40.5 to about 42.7 lbs/ft. An example of such a polymeric non-woven fabric having the aforementioned weight and grab tensile strength is a spun bonded non-woven fabric commercially available under the trademark LUTRADUR® from Carl Freudenberg, Hohnerweg 2, Weinheim an der Bergstrasse 6940, Fed Rep Germany.

Another example of a suitable polymeric non-woven fabric is a needle-punched polymeric fabric formed from a material such as polypropylene, polyethylene, or polyester (calendared or uncalendared). Needle-punched fabrics are essentially formed by disposing a plurality of strands in a sheet-like formation and passing a number of needles through the strands to interlock at least a portion of the strands with other strands to mechanically bond the plurality of strands into a sheet of fabric. In some embodiments, it is further desirable that the needle-punched fabric be calendered, or passed between heated plates or rollers to provide the fabric with a smoother surface.

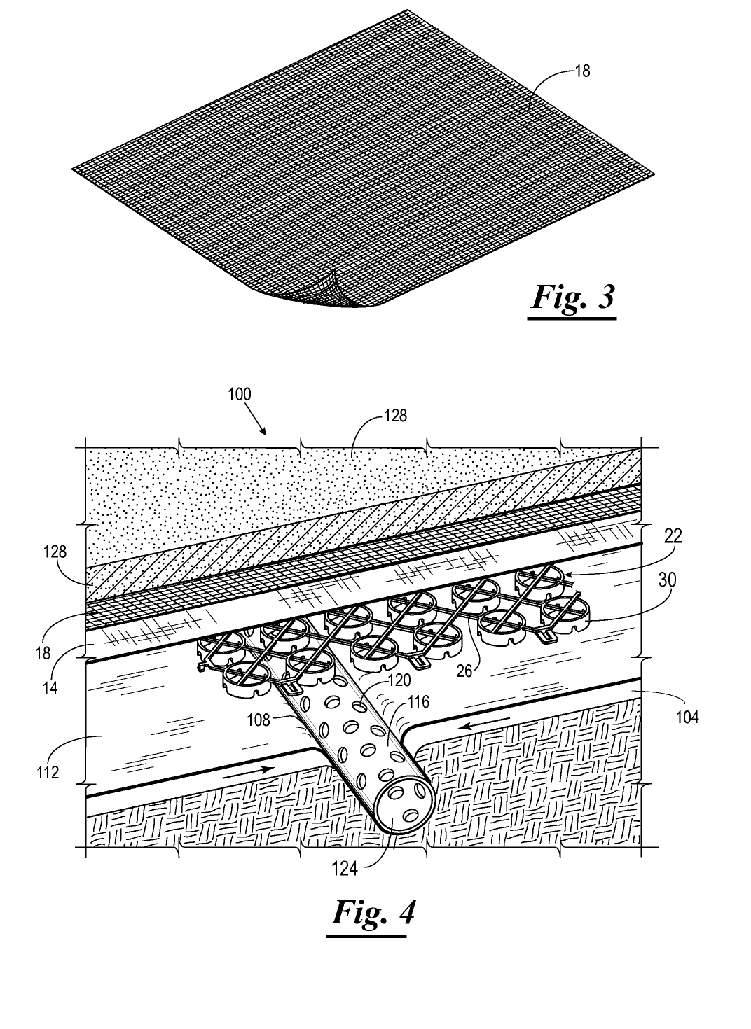

Referring now to FIG. 3, the support layer 18 may be formed of any durable material that is at least as permeable to liquids as the non-woven fabric of the filter layer 14 and having sufficient strength to support granular material, such as sand or gravel and sand, as well as resist puncturing by an object, such as a rake, when the composite material 10 is used in a sand bunker of a golf course. For example, the support layer 18 may be formed of woven or knitted fabrics, metal screen or mesh, polymeric sheeting, or any other suitable material. For many embodiments, the support layer may be formed of durable geotextile fabrics having the desired properties. Generally, such durable geotextile fabrics are formed of a plurality of interrelated strands, of which each strand may be of monofilament construction or be formed from a plurality of fibers. The strands of such durable fabrics may be interrelated by knitting or weaving, may be thermally-bonded, or may be joined or otherwise interrelated in any other suitable fashion.

Some such suitable geotextile fabrics may have a weight ranging from about 1.5 oz/yard² to about 8 oz/yard² and a grab tensile strength of from about 35 to about 1445 lbs/ft. An example of one such durable, geotextile fabric which can be employed in the practice of the present invention is a knitted polyethylene tape fabric that is commercially available from Volm Companies, Inc., 1804 Edison Street, Antigo, Wis. 54409. Another example of a suitably-durable geotextile fabric is a polypropylene, continuous-filament heat-bonded fabric that is commercially-available under the trademark TYPAR from Reemay, Inc., 70 Old Hickory Blvd., Old Hickory, Tennessee 37138-3651.

In one preferred method of forming the composite material 10, the filter layer 14 may be a needle-punched fabric that is simultaneously assembled or bonded with the support layer 18 during the process of creating the filter layer 14 by a needle-punching process. In such an embodiment, the support layer 18 is preferably formed of a plurality of strands that are interrelated by knitting or weaving so as to permit the strands of filter layer 14 to be forced through the strands of the support layer 18 to interlock at least a portion of the strands of the support layer 18 with at least a portion of the strands of the filter layer 14, thereby mechanically bonding the layers 14 and 18 to form the composite filter material 10.

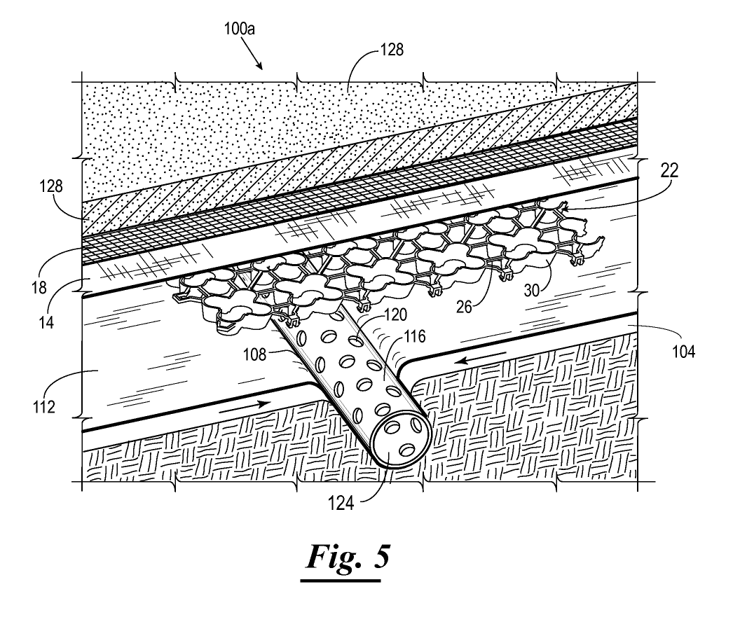

Referring now to FIGS. 4 and 5, other embodiments of the composite filter material 10 comprise a filter layer 14 and support layer 18, both described above, as well as a drainage panel 22 bonded to at least one of the filter layer 14 or the support layer 18. The drainage panel 22 is preferably assembled and bonded to at least one of the filter layer 14 or the support layer 18 by any suitable technique known to those skilled in the art, including, but not limited to, mechanical techniques (including sonic, needle punch, sewing, stapling, rivets and the like), and/or chemical and/or thermal techniques, provided that the method of bonding the filter layer 14 and the support layer 18 together does not substantially interfere with the water permeability of the composite material 10 or the integrity of the composite material 10.

As shown, the drainage panel 22 preferably includes a laterally-extensive backing grid 26 and a plurality of spaced-apart support members 30 extending from the backing grid 26. The drainage panel 22 is constructed such that liquids can flow through the backing grid 26 and between the support members 30. Although the backing grid 26 is shown in a regular, grid-like pattern, the backing grid 26 may be formed in any shape, pattern, or the like that maintains the support members 30 is a pre-determined arrangement. For example, the backing grid 26 may be formed from a solid sheet of material with a number of holes therethrough.

As with the backing grid 26, the support members 30 may be formed in any shape so as to permit water to flow through the backing grid 26. As shown, in some embodiments, the support members may have a cylindrical or other fanciful shape such that liquids are permitted to flow through the support members 30. The drainage panel 22 is preferably semirigid, that is, it is sufficiently rigid to maintain sufficient fluid flow pathways, yet is flexible enough to follow the contour of the surface on which it is placed. In other embodiments, the drainage panel may formed from more flexible materials, such as rubber, so long as the support members 30 retain enough strength to substantially maintain their shape.

One suitable drainage panel 22 is described in U.S. Pat. No. 7,108,454, issued Sep. 19, 2006, which is hereby incorporated by reference in its entirety. Another suitable drainage panel 22 is described in published Application No. US 2006/0120803, published Jun. 8, 2006, which is hereby incorporated by reference in its entirety.

Various embodiments of the composite material 10 may be well-suited to a variety of landscape elements, for example, a sandtrap for a golf course, a flower bed, a portion of a lawn or putting green, or nearly any other landscape element or area where improved drainage is desired. Specifically, FIGS. 4 and 5 depict portions of two embodiments of sandtraps 100 and 100a constructed in accordance with the present invention. The sandtrap is preferably formed by contouring a portion of earth to drain to a collection channel 108. The collection channel 108 is preferably sloped to direct liquid out of the sandtrap 100.

In the preferred embodiment of the sandtrap 100, the portion of earth 104 is covered with at least one layer of impermeable material 112 so as to prevent liquids from saturating the portion of earth 104, thereby ensuring that at relatively larger portion of liquid entering the sandtrap 100 is directed to the collection channel 108. The impermeable material 112 may be a sheet of impermeable material, such as plastic, may be a layer of cement, cement kiln dust (CKD), or the like, or may be a sealant, such as a liquid, added to the portion of earth 104, so as to seal the surface of the portion of earth 104. In other embodiments, the impermeable material 112 may be omitted.

A tube 116 is preferably disposed within the collection channel 108 to assist in directing liquids out of the sandtrap 100. The tube 116 preferably has at least one opening 120 for collecting liquid from within the sandtrap 100 and at least one opening 124 for discharging liquid outside the sandtrap 100. It will be appreciated by those skilled in the art that in many embodiments it will be preferable to have a plurality of openings 120 for collecting liquid from within the sandtrap 100 so as to maximize drainage. The tube 116 may be formed of any suitable material, for example PVC, iron, aluminum, or the like.

Once the impermeable material 112 and the tube 116 are in place over the portion of earth 104, at least one layer of composite filter material 10 is placed over the portion of earth 104. In the preferred embodiment, the composite filter material 100 comprises a drainage panel 22, a filter layer 14, and a support layer 18, all of which are described above. In other embodiments, a layer of gravel or other granular, liquid-permeable material may be substituted for the drainage panel 22 and a composite filter material 10 having a filter layer 14 and a support layer 18 may be used.

The composite filter material 10 is then preferably covered with a layer of sand 128. As will be appreciated by those skilled in the art, the composite filter material 10 may be covered with layers of other material, such as soil, or covered with multiple layers, such as sand, soil, and sod, depending upon the particular landscape element or area.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. A composite filter material comprising:
a flexible, liquid-permeable non-woven fabric filter layer having a plurality of openings sized to permit liquids and silt particles to pass through the filter layer while preventing sand particles from passing through the filter layer; and,
a flexible, liquid-permeable support layer bonded to the filter layer and having a grab tensile strength greater than that of the filter layer, the support layer having a plurality of openings such that the support material is at least as permeable to liquids as the filter fabric.

2. The composite filter material of claim 1, wherein the filter layer has a grab tensile strength greater than about 30 pounds per foot.

3. The composite filter material of claim 2, wherein the filter layer has a grab tensile strength between about 40 pounds per foot and about 43 pounds per foot.

4. The composite filter material of claim 1, wherein the support layer has a grab tensile strength between about 35 pounds per foot and about 1445 pounds per foot.

5. The composite filter material of claim 1, wherein the filter layer is one of a spun-bonded or needlepunched fabric.

6. The composite filter material of claim 5, wherein the filter layer is a calendered needlepunched fabric.

7. The composite filter material of claim 5, wherein the filter layer is a spun-bonded fabric having a grab tensile strength between about 40 pounds per foot and about 43 pounds per foot.

8. The composite filter layer of claim 1, wherein the support layer is a polymeric continuous-filament heat-bonded fabric.

9. The composite filter material of claim 1, wherein the support layer is one of a woven or knitted polymeric fabric.

10. The composite filter material of claim 9, wherein the support layer has a grab tensile strength between about 35 pounds per foot and about 1445 pounds per foot.

11. The composite filter material of claim 1, wherein the filter layer is formed of a plurality of strands and the support layer is formed of a plurality of interrelated strands, at least a portion of the strands of the filter layer interlocking at least a portion of the strands of the support layer to mechanically bond the filter layer to the support layer.

12. The composite filter material of claim 11, wherein the mechanical bond between the filter layer and the support layer is formed by needlepunching.

13. The composite filter material of claim 1, further comprising a drainage panel bonded to at least one of the filter layer and the support layer, the drainage panel having a laterally-extensive backing grid and a plurality of spaced-apart support members projecting from the backing grid whereby fluid may flow through the backing grid and between the support members.

14. A method of manufacturing a composite filter material, comprising the steps of:
layering a sheet of flexible, liquid-permeable support material and a sheet of flexible, liquid-permeable non-woven filter fabric having a plurality of openings sized to permit liquids and silt particles to pass through the filter fabric while preventing sand particles from passing through the filter fabric, the support material having a grab tensile strength greater than that of the filter fabric, the support material having a plurality of openings such that the support material is at least as permeable to liquids as the filter fabric; and,
bonding the filter fabric and the support material.

15. The method of claim 14, further comprising the step of bonding at least one of the support material or the filter fabric to drainage panel having a laterally-extensive backing grid and a plurality of spaced-apart support members projecting from the backing grid whereby fluid may flow through the backing grid and between the support members.

16. The method of claim 14, wherein the filter fabric is formed of a plurality of strands, the support material is formed of a plurality of interrelated strands, and the step of bonding the filter fabric to the support material comprises needlepunching the filter fabric and the support material to cause at least a portion of the strands of the filter fabric to interlock with at least a portion of the strands of the support layer to mechanically bond the filter fabric and the support material.

17. The method of claim 16, further comprising the step of bonding at least one of the support material or the filter fabric to a drainage panel having a laterally-extensive backing grid and a plurality of spaced-apart support members projecting from the backing grid whereby fluid may flow through the backing grid and between the support members.

18. A method of manufacturing a composite filter material, comprising the steps of:
forming a sheet of non-woven filter fabric by needlepunching a plurality of strands, the filter fabric being flexible, liquid-permeable, and having a plurality of openings sized to permit liquids and silt particles to pass through the filter fabric while preventing sand particles from passing through the filter fabric; and,
bonding the sheet of filter fabric to a sheet of support material by needlepunching the filter fabric and the support material, the support material having a grab tensile strength greater than that of the filter fabric, the support material having a plurality of openings therethrough such that the support material is at least as permeable to liquids as the filter fabric.

19. The method of claim 18, further comprising the step of bonding at least one of the support material or the filter fabric to a drainage panel having a laterally-extensive backing grid and a plurality of spaced-apart support members projecting from the backing grid whereby fluid may flow through the backing grid and between the support members.

20. The method of manufacturing a composite filter material of claim 18, wherein the steps of forming a sheet of non-woven filter fabric and bonding the sheet of filter fabric to a sheet of support material are performed simultaneously.

21. The method of claim 20, further comprising the step of bonding one of the support material or the filter fabric to a drainage panel having a laterally-extensive backing grid and a plurality of spaced-apart support members projecting from the backing grid whereby fluid may flow through the backing grid and between the support members

22. The composite filter material formed by the method of claim 20.

23. The composite filter material formed by the method of claim 21.

24. A sand trap comprising:
a portion of earth contoured to drain to at least one collection channel sloped to direct liquid out of the sand trap;
a composite filter material covering the portion of earth, the composite filter material comprising:
a flexible, liquid-permeable non-woven fabric filter layer having a plurality of openings sized to permit liquids and silt particles to pass through the filter layer while preventing sand particles from passing through the filter layer; and,
a flexible, liquid-permeable support layer bonded to the filter layer and having a grab tensile strength greater than that of the filter layer, the support layer having a plurality of openings such that the support material is at least as permeable to liquids as the filter fabric; and,
a layer of sand covering the composite drainage material.

25. The sand trap of claim 24, wherein the composite filter material further comprises a drainage panel bonded to at least one of the filter layer and the support layer, the drainage panel having a laterally-extensive backing grid and a plurality of spaced-apart support members projecting from the backing grid whereby fluid may flow through the backing grid and between the support members

26. The sand trap of claim 25, further comprising a tube disposed within the collection channel, the collection tube having at least one opening for collecting liquid and at least one opening for discharging liquid outside the sandtrap.

27. The sand trap of claim 25, further comprising at least one layer of impermeable material between the portion of earth and the composite filter material.

28. The sand trap of claim 27, further comprising a tube disposed within the collection channel between the at least one layer of impermeable material and the composite filter material, the collection tube having at least one opening for collecting liquid from the sandtrap and at least one opening for discharging liquid outside the sand trap.

29. A method of constructing a sandtrap, the method comprising:
shaping a portion of earth to drain to at least one drainage channel sloped to direct liquid out of the sand trap;
covering the portion of earth with a composite filter material comprising:
a flexible, liquid-permeable non-woven fabric filter layer having a plurality of openings sized to permit liquids and silt particles to pass through the filter layer while preventing sand particles from passing through the filter layer; and,
a flexible, liquid-permeable support layer bonded to the filter layer and having a grab tensile strength greater than that of the filter layer, the support layer having a plurality of openings such that the support material is at least as permeable to liquids as the filter fabric; and,
covering the composite drainage material with a layer of sand.

30. The method of claim 29, wherein the composite filter material further comprises a drainage panel bonded to at least one of the filter layer and the support layer, the drainage panel having a laterally-extensive backing grid and a plurality of spaced-apart support members projecting from the backing grid whereby fluid may flow through the backing grid and between the support members.

31. The method of claim 31, further comprising the step of positioning a collection tube within the drainage channel, the collection tube having at least one opening for collecting liquid and at least one opening for discharging liquid outside the sandtrap.

32. The method of claim 30, further comprising the step of positioning at least one layer of impermeable material between the portion of earth and the composite filter material.

33. The method of claim 32, further comprising the step of positioning a collection tube within the drainage channel between the at least one layer of impermeable material and the composite filter material, the collection tube having at least one opening for collecting liquid from the sandtrap and at least one opening for discharging liquid outside the sand trap.
